(19) United States
(12) Patent Application Publication
(10) Pub. No.: US 2016/0239656 A1
(43) Pub. Date: Aug. 18, 2016

(54) TEST FOR DISTINGUISHING BETWEEN A HUMAN AND A COMPUTER PROGRAM

(71) Applicant: Jeff Yan, Newcastle upon Tyne (GB)

(72) Inventor: Jeff Yan, Newcastle upon Tyne (GB)

(21) Appl. No.: 15/027,958

(22) PCT Filed: Oct. 7, 2014
(86) PCT No.: PCT/GB2014/053025

§ 371 Date: Apr. 7, 2016

(30) Foreign Application Priority Data
Oct. 7, 2013 (GB) 1317682.1

(51) Int. Cl. G06F 21/36; G06F 3/0484; G06T 1/00; G06F 3/0488; G06T 3/00; G06T 11/60

(52) U.S. Cl. CPC G06F 21/36; G06T 3/00; G06T 11/60; G06T 1/00; G06F 3/0488; G06F 3/04842

(57) ABSTRACT

A method for distinguishing between a human and a computer program is described. The method comprises the steps of providing a first output for indicating a set of one or more graphical entities, and displaying an image comprising an arrangement of a plurality of graphical entities. The graphical entities of the image comprise at least the set of one or more graphical entities indicated by the first output. One or more of the graphical entities of the image are obfuscated. The method comprises the further steps of receiving an input for selecting one or more points on the image, comparing the selected points with position information indicating the positions in the image of the set of one or more graphical entities indicated by the first output, and determining that the received input has been made by a human if the selected points correspond to the position information.

### BACKGROUND OF THE INVENTION

1. Field of the invention

The present invention relates generally to a test or challenge for distinguishing between a human and a computer program. For example, certain embodiments of the present invention provide a security test for allowing a computer system (e.g. a server) to automatically distinguish between a human user and a computer program (e.g. a “bot”), thereby enabling the computer system to prevent or restrict unauthorised or undesirable activities (e.g. information download or hacking activities) instigated by the computer program.

2. Description of the Related Art

The ability of a computer system (e.g. a server) to distinguish between a human user and an external computer program is desirable in many situations. For example, some computer programs, referred to as bots, are designed to perform automated tasks, often highly repetitively, over a network (e.g. the Internet). Many bots are created by computer hackers to perform tasks involving unauthorised or undesirable activities. For example, some bots are designed to automatically fetch large volumes of information from a remote web server. This type of activity is often undesirable since it can overload the server, use a large proportion of the available bandwidth, and therefore slow down or prevent other users from accessing information provided by the server. Other bots are designed to perform hacking activities, for example exhaustive password searches in order to gain unauthorised access to user accounts (e.g. email accounts). This type of activity is clearly undesirable from a security point of view.

Accordingly, various techniques have been developed for enabling a computer system to automatically distinguish between a human and a computer program. Many of these techniques are based on presenting a test or challenge that is relatively easy for a human to pass, but difficult for an automated computer program to pass. Techniques of this type are sometimes referred to as CAPTCHA (Completely Automated Public Turing test to tell Computers and Humans Apart) programs. A computer system may restrict certain activities (e.g. access to data download or the ability to enter a password to log into an account) to human users only by first presenting a CAPTCHA type test, which must be passed before the computer system allows the activity.

FIGS. 1a and 1b illustrate typical CAPTCHA type tests. In these examples, a string of characters are displayed on a screen, and the user is required to correctly enter the displayed characters in a text box using a keyboard in order to pass the test. The effectiveness of these tests depends on the user's ability to correctly identify the displayed characters, and the inability of an automatic computer program to do the same. In order to achieve this, the displayed characters are typically obfuscated in some way, for example by being distorted and/or overlapped.

One problem with existing CAPTCHA type techniques is striking a balance between maintaining acceptable levels of both security and ease of use by a human user. For example, increasing the level of obfuscation applied to the characters reduces the likelihood of an automatic computer program being able to pass the test, and therefore increases security. On the other hand, if the level of obfuscation applied is too high, even a human may find it difficult to correctly identify the characters and pass the test, resulting in user inconvenience.

For example, in the test illustrated in FIG. 1a, the level of obfuscation applied to the characters is relatively low. Although this allows a user to easily identify the correct characters, the level of obfuscation may be too low to prevent an automatic computer program from passing the test. On the other hand, in the test illustrated in FIG. 1b, the level of obfuscation applied to the characters is relatively high. Although this level of obfuscation makes it difficult for an automatic computer program to pass the test, a human user may also find it difficult to correctly identify the characters, and may therefore be required to take multiple tests before one is passed.

Accordingly, what is desired is a test or challenge for distinguishing between a human and a computer program that maintains acceptable levels of both security and ease of use by a human user.

### SUMMARY OF THE INVENTION

It is an aim of certain exemplary embodiments of the present invention to address, solve and/or mitigate, at least partly, at least one of the problems and/or disadvantages associated with the related art, for example at least one of the problems and/or disadvantages described above. It is an aim of certain exemplary embodiments of the present invention to provide at least one advantage over the related art, for example at least one of the advantages described below.

The present invention is defined by the independent claims. Advantageous features are defined by the dependent claims.

In accordance with an aspect of the present invention, there is provided a method according to claim 1, 34, 35 or 43.

In accordance with another aspect of the present invention, there is provided a client device according to claim 32.

In accordance with another aspect of the present invention, there is provided a server according to claim 33.

In accordance with another aspect of the present invention, there is provided a system according to claim 31.

In accordance with another aspect of the present invention, there is provided a computer program comprising instructions arranged, when executed, to implement a method, apparatus and/or system in accordance with any aspect or claim disclosed herein.

In accordance with another aspect of the present invention, there is provided a machine-readable storage storing a computer program according to the preceding aspect.

Other aspects, advantages, and salient features of the present invention will become apparent to those skilled in the art from the following detailed description, which, taken in conjunction with the annexed drawings, disclose exemplary embodiments of the present invention.

### BRIEF DESCRIPTION OF THE DRAWINGS

The above and other aspects, and features and advantages of certain exemplary embodiments and aspects of the present invention will be more apparent from the following detailed description, when taken in conjunction with the accompanying drawings, in which:

FIG. 1a illustrates a first example of a CAPTCHA type test for distinguishing between a human and a computer program;

FIG. 1b illustrates a second example of a CAPTCHA type test for distinguishing between a human and a computer program;

FIG. 2 illustrates a system embodying the present invention;

FIG. 3 illustrates an exemplary method for allowing a server to determine whether a request for information and/or a service received from a client device has originated from a human user or a computer program;

FIG. 4 illustrates a first exemplary test for distinguishing between a human and a computer program according to an exemplary embodiment of the present invention;

FIG. 5 illustrates a second exemplary test for distinguishing between a human and a computer program according to an exemplary embodiment of the present invention;

FIG. 6 illustrates an exemplary technique for highlighting selections made by a user;

FIG. 7 illustrates an image for a test comprising a graphical symbol “ [symbol] ”;

FIG. 8a illustrates a first example of reference coordinates and reference areas for two characters, “A” and “©”;

FIG. 8b illustrates a second example of reference coordinates and reference areas for two characters, “A” and “©”;

FIGS. 9a-d illustrate various examples of obfuscation that may be applied to the image used on the test illustrated in FIG. 5;

FIGS. 10a-d illustrate various examples of rectangular bounding boxes for various certain characters;

FIGS. 11a-b illustrate various examples of touching points for certain characters;

FIGS. 12a-e illustrate various examples of character boxes for certain characters;

FIGS. 13a-d illustrate further examples of character boxes for certain characters;

FIGS. 14-17 illustrate an exemplary method for modifying a character box;

FIGS. 18a-c illustrate an exemplary method for arranging characters in an image;

FIGS. 19a-h illustrate the various steps in the method of FIG. 19;

FIGS. 20a-b illustrate examples of an image resulting from the method of FIG. 18;

FIG. 21 illustrates an example of a fuzzy area in which the character boxes of two characters overlap;

FIGS. 22a-c illustrate various examples of a user selection of a character in the image; and

FIG. 23 illustrates a case in which the user has selected a point in the fuzzy area of overlap between the bounding boxes of two characters.

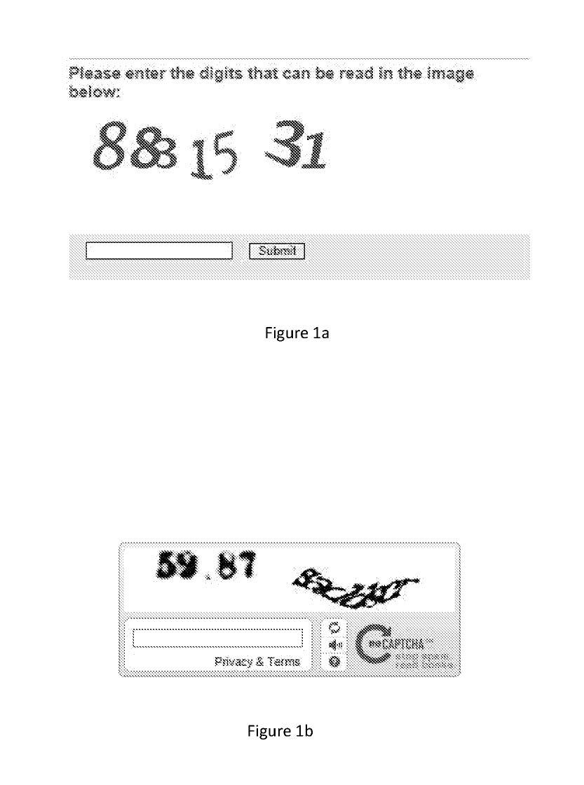

### DETAILED DESCRIPTION OF EXEMPLARY EMBODIMENTS

The following description of exemplary embodiments of the present invention, with reference to the accompanying drawings, is provided to assist in a comprehensive understanding of the present invention. The description includes various specific details to assist in that understanding but these are to be regarded as merely exemplary. Accordingly, those of ordinary skill in the art will recognize that various changes and modifications of the embodiments described herein can be made without departing from the scope of the present invention, as defined by the claims.

The terms, words and phrases used in the following description and claims are not limited to the bibliographical meanings, but, are used to enable a clear and consistent understanding of the present invention.

In the description and Figures of this specification, the same or similar features may be designated by the same or similar reference numerals, although they may be illustrated in different drawings.

Detailed descriptions of structures, constructions, functions or processes known in the art may be omitted for clarity and conciseness, and to avoid obscuring the subject matter of the present invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, characteristics, properties and/or groups thereof.

Throughout the description and claims of this specification, the singular forms “a,” “an,” and “the” include plural referents unless the context dictates otherwise. Thus, for example, reference to “an object” includes reference to one or more of such objects.

Throughout the description and claims of this specification, language in the general form of “X for Y” (where Y is some action, process, activity, operation or step and X is some means for carrying out that action, process, activity, operation or step) encompasses means X adapted, configured or arranged specifically, but not exclusively, to do Y.

Features, elements, components, integers, steps, processes, operations, functions, characteristics, properties and/or groups thereof described in conjunction with a particular aspect, embodiment or example of the present invention are to be understood to be applicable to any other aspect, embodiment or example described herein, unless incompatible therewith.

The methods described herein may be implemented in any suitably arranged apparatus or system comprising means for carrying out the method steps.

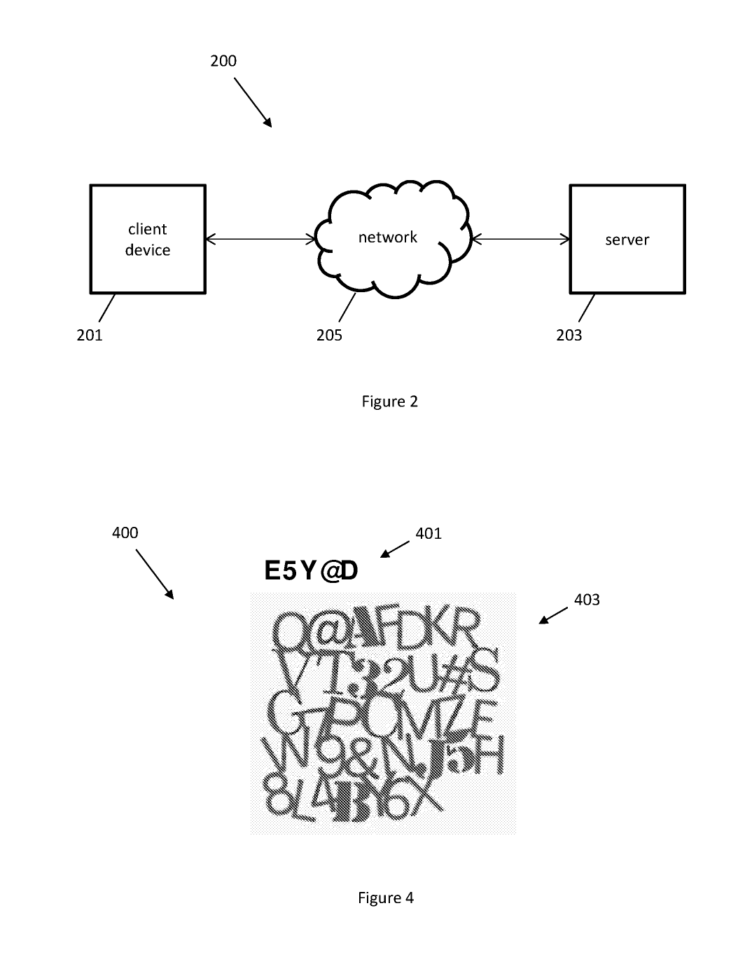

FIG. 2 illustrates a system embodying the present invention.

As illustrated in FIG. 2, the system 200 comprises a client device 201 and a server 203. The client device 201 and the server 203 may be connected by a network 205, for example the Internet or a telecommunications network, allowing signals to be exchanged between the client device 201 and the server 203. The server 203 may comprise any suitable type of server providing information and/or services which may be accessed over the network 205. For example, the server 203 may be in the form of a web server providing one or more web pages. The client device 201 may comprise any suitable type of device that may access information and/or services provided by the server 203. For example, the client device 201 may be in the form of a mobile/portable terminal (e.g. mobile telephone), hand-held device or personal computer (e.g. desktop computer or laptop computer).

In the system 200 illustrated in FIG. 2, when the client device 201 transmits a request for access to information and/or a service provided by the server 203, a procedure may be carried out that allows the server 203 to determine whether the request has originated from a human user of the client device 201 or from a computer program (e.g. a bot).

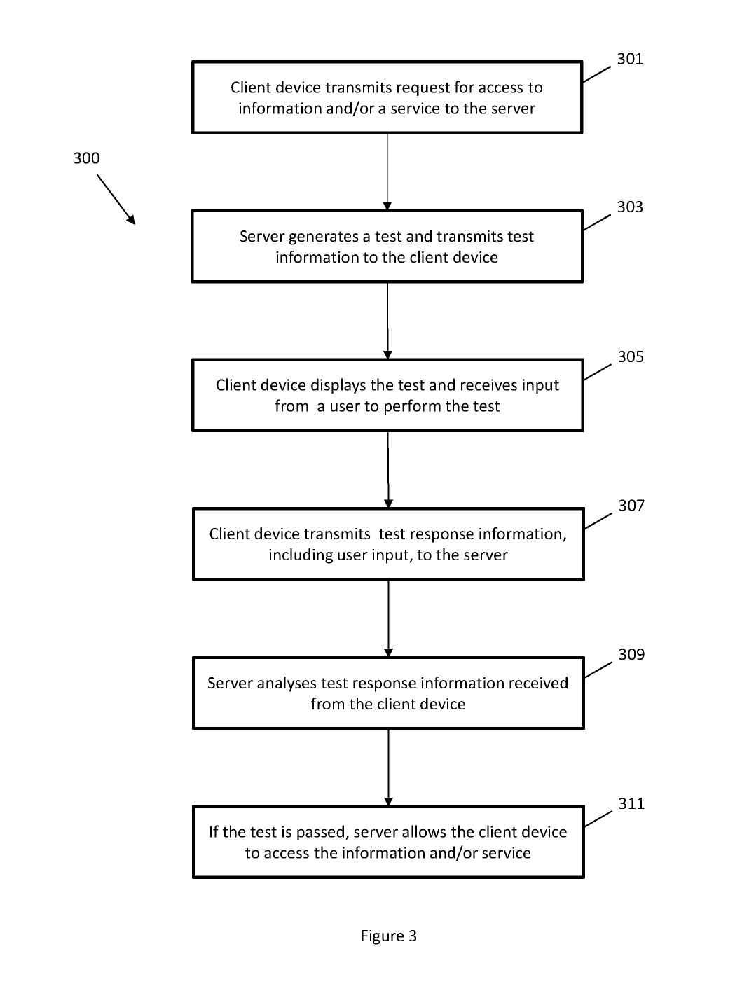

An exemplary method 300 is illustrated in FIG. 3. In a first step 301, the client device 201 transmits a request for access to information and/or a service to the server 203 via the network 205. In a next step 303, the server 203 generates a test and transmits test information to the client device 201 via the network 205. In a next step 305, the client device 201 displays the test based on the received test information and receives input from the user of the client device 201 while the user performs the test. In a next step 307, the client device 201 transmits test response information, including information based on the user input, to the server 203 via the network 205. In a next step 309, the server 203 analyses the test response information received from the client device 201 to determine if the test has been passed. In a next step 311, if the test response information indicates that the user has passed the test, the server 203 allows the client device 201 to access the information and/or service.

In step 305, the test may require the user to provide multiple individual inputs. In this case, in a variation of steps 305 and 307, a portion of test response information may be transmitted to the server 203 (e.g. as packet data) each time the user provides an individual input. Alternatively, test response information may be buffered by the client device 201 as the test is conducted, and buffered test response information may be transmitted to the server 203, for example upon completion of the test. In the case that the server 203 receives test response information in portions as the test is conducted, in a variation of step 309, the server 203 may analyse portions of test response information as it is received. Alternatively, the server 203 may buffer the received portions of test response information and analyse the buffered test response information, for example upon completion of the test.

FIG. 2 illustrates a specific exemplary system embodying the present invention. However, the skilled person will appreciate that the present invention is not limited to this particular arrangement. For example, in alternative embodiments, the client device 201 and the server 203 may communicate without using a network. For example, the client device 201 and server 203 may communicate directly. In another example, the client device 201 may request information from another server, rather than from the server 203, but the server 203 may determine whether the request has originated from a human or a computer program on the other server's behalf.

In general, the present invention may be implemented in any suitable system comprising a first entity and a second entity, where the first entity performs some activity that another entity wishes to determine whether the activity is a result of a human or a computer program, and where the second entity is used to determine whether the activity is a result of a human or a computer program.

In an exemplary embodiment, the client device 201 may comprise: a transmitter for transmitting a request for access to information and/or a service, and for transmitting test response information to the server 203; a receiver for receiving test information from the server 203 and for receiving authorisation to access the information and/or service; a display for displaying a test; an input unit for receiving input from the user (e.g. selection of points in an image of the test); a memory for storing various information (e.g. data and software) used and/or generated during operation of the client device 201; and a controller for controlling overall operation of the client device 201.

In an exemplary embodiment, the server 203 may comprise: a test generating unit for generating a test; a transmitter for transmitting test information to the client device 201, and for transmitting a signal indicating whether or not the test has been passed; a receiver for receiving a request to generate a test, and for receiving test response information from the client device 201; and a test response analysing unit for analysing the test response information to determine whether or not the test has been passed.

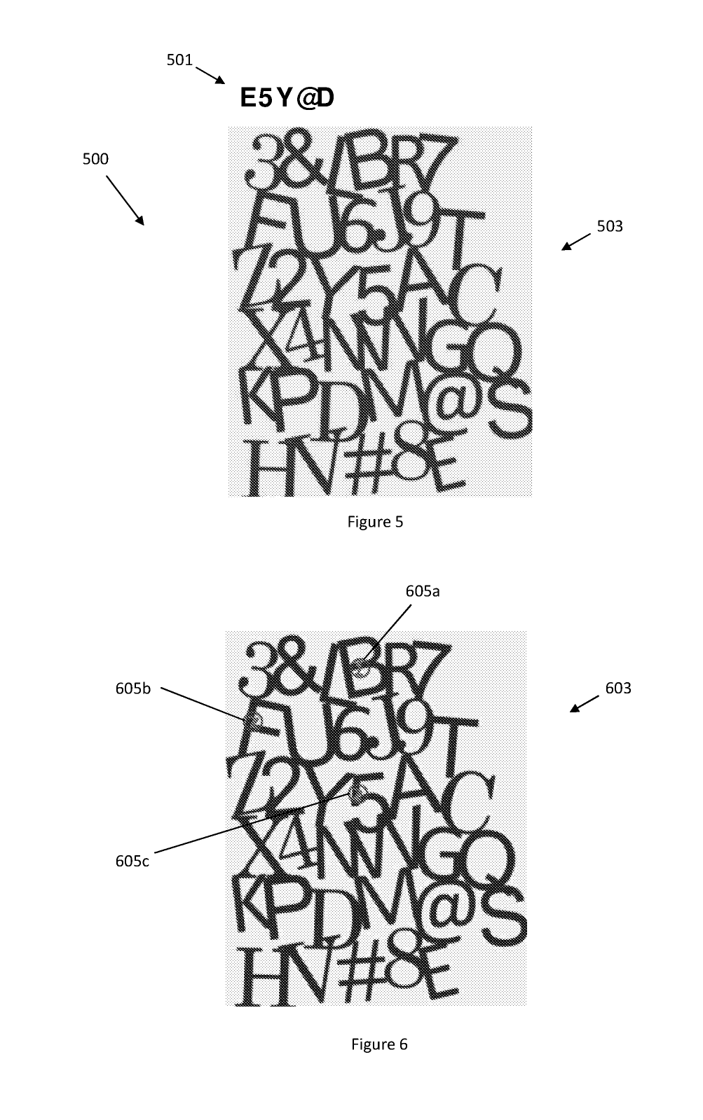

FIG. 4 illustrates an exemplary test for distinguishing between a human and a computer program according to an exemplary embodiment of the present invention. For example the test 400 illustrated in FIG. 4 may be applied in the system 200 illustrated in FIG. 2 and the method 300 illustrated in FIG. 3.

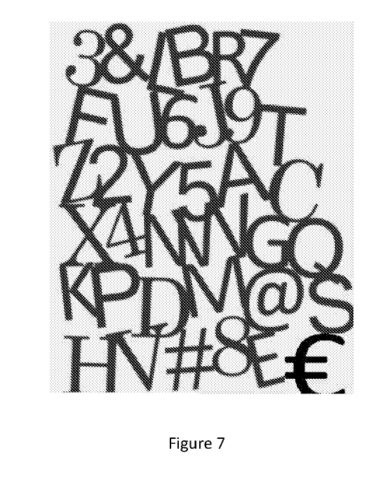

In the example of FIG. 4, the test 400 comprises a first output in the form of a string 401 of characters (e.g. letters, numbers, and any other suitable types of characters) and/or symbols (e.g. punctuation marks, phonetic symbols, currency symbols, mathematical symbols, icons, graphics, graphical symbols, and any other suitable types of symbols). For example, FIG. 7 illustrates an image for a test comprising a graphical symbol “ [symbol] ”. Hereafter, all types of characters and symbols are referred to collectively as “characters” or “graphical entity” for convenience. The test 400 further comprises a second output in the form of an image 403 or “input pad”. The string 401 may be a plaintext string that has relatively little or no obfuscation applied to the characters forming the string 401. Accordingly, it is easy for a human user (and also a computer program) to correctly identify the characters forming the string 401.

The image 403 comprises an arrangement or configuration of various characters. In particular, the image 403 comprises at least the characters occurring within the string 401. The image 403 may also comprise one or more additional characters not occurring in the string 401. In the illustrated example, the arrangement of characters comprises a two-dimensional arrangement of characters. For example, a two-dimensional arrangement may comprise an arrangement in which characters are arranged from left-to-right (or right-to-left) and from top-to-bottom (or bottom-to-top). However, in alternative embodiments, the arrangement of characters may comprise a one-dimensional arrangement of characters. For example, a one-dimensional arrangement may comprise an arrangement in which characters are arranged from left-to-right (or right-to-left), for example in a single row, or alternatively are arranged from top-to-bottom (or bottom-to-top), for example in a single column. Although a one-dimensional arrangement may provide less security than a two-dimensional arrangement, a user may find a one-dimensional arrangement easier or more convenient to use. The image 403 may be any suitable size and/or shape and is not limited to the specific example illustrated in FIG. 4.

In some embodiments, a user may be given the option to zoom-in and zoom-out of the image. This option may be advantageous in cases where a human user cannot clearly distinguish one or more of the characters in the image 403. In this case, the user may zoom-in to the image to improve clarity. However, zooming-in would not typically assist a computer program in correctly identifying the characters in the image 403.

The characters forming the image 403 may be arranged in any suitable arrangement or configuration. In the example illustrated in FIG. 4, the characters are arranged in a two-dimensional configuration and are arranged roughly in rows. However, in other examples, the characters may be additionally or alternatively arranged roughly in columns, or any other suitable configuration, for example in a spiral pattern, other pattern, randomly, or quasi-randomly in one or two dimensions.

At least some of the characters forming the image 403 have at least some level of obfuscation applied to them, for preventing a computer program from being able to correctly identify the characters in the image 403. Any suitable type of obfuscation may be applied to the characters for this purpose, some example of which will now be described.

For example, the obfuscation may be achieved by displaying the characters in a variety of different fonts and/or sizes.

The obfuscation may be additionally or alternatively achieved by applying one or more linear or non-linear transformations to a character, or a group thereof. The transformations may comprise, for example, one or more shape-deforming transformations, for example stretching, scaling, tapering, twisting, bending, shearing, warping, and the like. The transformations may additionally or alternatively comprise one or more other types of transformation, for example rotation, reflection, and the like. The skilled person will appreciate that the transformations may additionally or alternatively comprise one or more common or standard transformations.

The obfuscation may be additionally or alternatively achieved by applying one or more image processing operations to a character, or a group thereof. The image processing operations may comprise, for example, blurring, shading, patterning, outlining, silhouetting, colouring, and the like. The skilled person will appreciate that the image processing operations may additionally or alternatively comprise one or more common or standard image processing operations.

The obfuscation may be additionally or alternatively achieved by overlapping at least some of the characters. For example, a character may be overlapped by N neighbouring characters (where N=1, 2, 3, 4, . . . ). The neighbouring characters of a character may include one or more neighbouring characters in any directions. For example, the neighbouring characters may include any combination of an upper neighbour, a lower neighbour, a left neighbour, a right neighbour, and one or more diagonal neighbours. A character may be overlapped by neighbouring characters in one or two dimensions.

The obfuscation may be additionally or alternatively achieved by superimposing another image, pattern, and the like, over the image 403. For example, a cross-cross pattern of randomly orientated lines may be superimposed over the image 403.

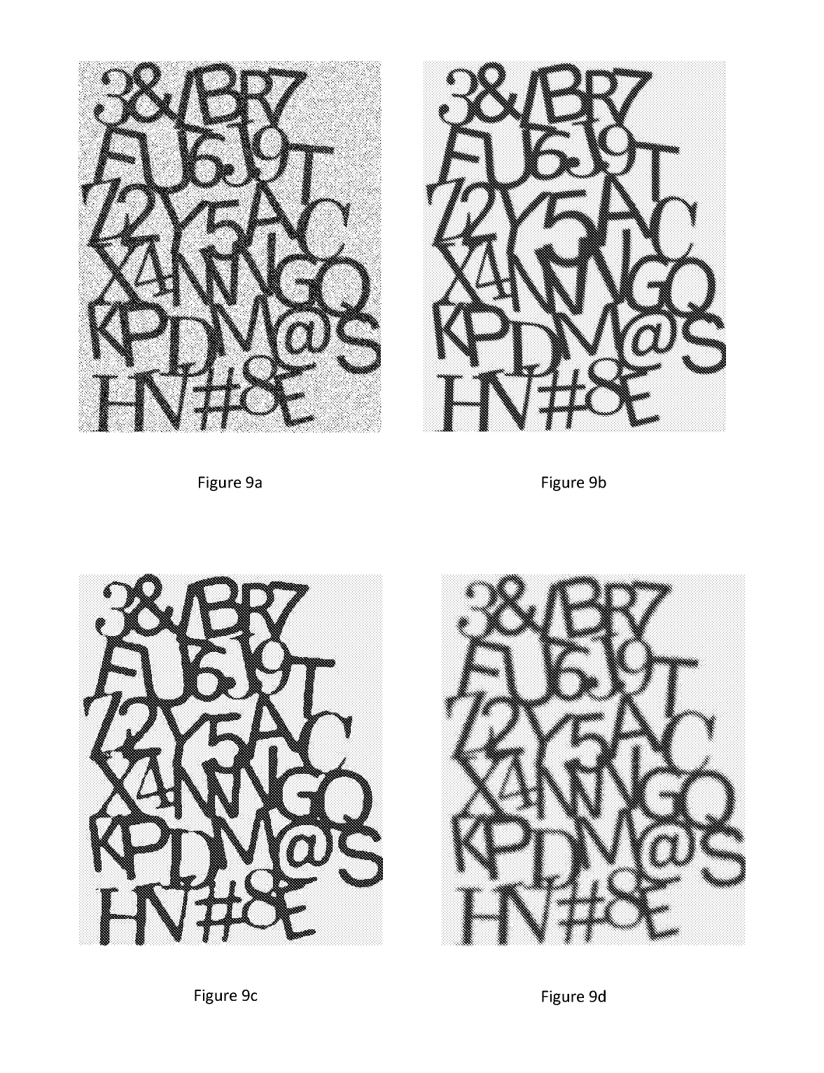

FIGS. 9a-d illustrate various examples of obfuscation that may be applied to the image 503 used in the test 500 illustrated in FIG. 5. For example, FIG. 9a illustrates an example in which speckling is applied the image. FIG. 9b illustrates an example in which distortion is applied to a middle portion of the image. FIG. 9c illustrates an example in which the edges of the characters are smudged. FIG. 9d illustrates and example in which blurring is applied to the image.

In the embodiment illustrated in FIG. 4, the image 403 is a static image. However, in alternative embodiments, the image 403 may be a time-varying image, moving image, animated image, and the like. For example, in some embodiments, one or more of the characters may move along any suitable paths, which may be random or non-random. In one example, the characters may float randomly around the image 403. In another example, the characters may move in straight lines, either bouncing off the edges of the image 403 or disappearing from one side of the image and reappearing in the opposite side of the image.

The image 403 may be animated in other ways. For example the size or font of a character, or the transformation or image processing applied to a character, may vary over time. In another example, one or more of the characters may disappear from view for a time (e.g. a random time or predetermined time) and reappear, either in the same position in the image 403 or in a different position.

The degree and type of obfuscation applied to the characters forming the image 403 are applied such that a human user is able to correctly identify and locate certain characters in the image 403, while preventing a computer program from doing the same. The above and/or other methods of obfuscation may be applied in any suitable combination to achieve this goal.

The server 203 may generate the test 400 by generating a string 401 comprising a random sequence of characters, and then generating image information (e.g. an image file) defining an image 403, having a form as described above, comprising the characters occurring within the generated string 401 and optionally one or more additional characters. The server 203 then transmits test information, comprising the generated string 401 and generated image information defining the image 403, to the client device 201. The test information allows the client device 201 to reconstruct the test 400 and display the test 400 on a screen of the client device 201 to enable a user to conduct the test 400.

As described further below, the server 203 also stores information allowing the server 203 to determine the position within the image 403 of each character occurring within the string 401. This allows the server 203 to analyse test response information received back from the client device 201 to determine whether the user of the client device 201 has passed the test.

The server 203 may apply any suitable algorithm for generating the string 401. For example, the string 401 may be generated as a random or quasi-random set of characters.

Alternatively, the string 401 may be generated by selecting a word, phrase and/or brand name from a database of words, phrases and/or brand names. The server 203 may apply any suitable algorithm for generating the image 403. For example, an algorithm may be applied such that the characters forming the image contact and/or overlap in a suitable manner. For example, it is desirable that the characters contact and/or overlap sufficiently to prevent a computer program from correctly identifying the characters, but not so much to prevent a user from doing so.

As described above, the client device 201 receives test information from the server 203 and displays the test 400 to the user. For example, the test 400 may be implemented in the form of an applet (e.g. Java applet). In order to conduct the test illustrated in FIG. 4, the user identifies each character in the string 401 and selects the corresponding characters in the image 403.

In certain embodiments, the user may be provided with an option of requesting an entirely new test, for example if the user is unable to identify the characters in the image 403 or finds the image 403 confusing. Alternatively, the user may be provided with an option of requesting a new alternative image 403 while the string 401 remains the same. For example, FIG. 5 illustrates a second example of a test 500 comprising a string 501 that is the same as the string 401 used in the test illustrated in FIG. 4, but comprising a different image 503.

In certain embodiments, the user may be required to select the characters in the order that they appear in the string 401, or in another specified order, in order to pass the test. For example, the characters appearing in the string 401 may be individually and sequentially highlighted in a certain order, and the user may be required to select a character that is currently highlighted. Alternatively, it may be sufficient for the user to select the characters in any order.

In certain embodiments, the user may be required to select characters at certain times. For example, an icon or other visual indicator (e.g. a light bulb) displayed to the user may toggle between two states (e.g. on and off). The user may be required to select characters when the visual indicator is in a certain state (e.g. the light bulb is on).

The user may select a character in the image 403 using any suitable technique. For example, the user may use an input device, for example a mouse, tracker ball, touch pad, and the like, to move a cursor or pointer over the character and then actuate a button or key to select the character. Alternatively, if the image 403 is displayed on a touch screen, the user may touch the touch screen at the position of the character.

In certain embodiments, when the user has made a selection in the image 403, the selection, or the selected character, may be highlighted in the image 403, for example as feedback to the user. For example, FIG. 6 illustrates an exemplary technique for highlighting selections made by a user in an image 603. As illustrated in FIG. 6, the user's selections are highlighted by displaying a visual indicator 605a-c (e.g. a circle in the illustrated example) at the position of each user selection. Optionally, each visual indicator may comprise a number indicating the order in which the selections were made.

In certain embodiments, where feedback is provided to the user, the user may be provided with the option to review the selections made and to modify one or more of the selections before submitting the selections for analysis.

The client device 201 transmits test response information, comprising information relating to the user's selections of characters in the image 403, to the server 203. For example, the test response information may comprise the coordinates of the user's individual selections. A portion of test response information may be transmitted to the server each time the user selects a character in the image 403. Alternatively, the test response information may be buffered by the client device 400 as the test is conducted, and the buffered test response information transmitted to the server 203 following completion of the test 400.

In certain embodiments, the test response information may further comprise information indicating the order of the user's selections.

In certain embodiments, the test response information may further comprise time information indication time points at which the user's selections were made. The time information may comprise, for example an elapsed time from a predefined reference time (e.g. the time at which animation of the image 403 began). Time information may be required, for example, in embodiments using an image 403 in which the characters move. For example, in order to compare the position of a user's selection with the position of a character in the image 403 displayed to the user during the test 400, the server 203 needs to know the positions of the characters in the image 403 at the time the user made the selection. In cases where the characters move, the server uses information indicating the time the user made the selection, together with known motion of the characters in the image 403 to determine the positions of the characters at that time.

In cases where the user is allowed to zoom-in and zoom-out of the image 403, the client device 201 transmits zoom information to the server 203, either as part of the test response information, or separately. Zooming-in and zooming-out of the image 403 modifies the positions of the characters in the image 403 displayed to the user during the test 400. The zoom information allows the server 203 to correctly compare the position of a user's selection with the position of a character in the image 403 that has been zoomed-in or zoomed-out.

In order to determine whether the user has passed the test, the server 203 determines whether the user has correctly selected the characters in the image 403 using the test response information received from the client device 401 and the information previously stored when generating the test 400. For example, the server 203 compares information indicating the coordinates of the user's selections with information indicating the positions of the characters within the image 403 to determine which characters the user has selected. The server 203 then compares the selected characters with the characters occurring within the string 401.

For example, the information indicating the positions of the characters in the image 403 may comprise reference coordinates and/or a reference area associated with each character in the image 403. The reference coordinates of a specific character may comprise the position of a centre point of that character in the image 403. The reference area of a specific character may comprise an area having a certain shape (e.g. rectangle, square or circle) centred on the reference coordinates of that character. Alternatively, the reference area of a specific character may have the same or a similar shape to that character. The reference areas of each character may all have the same fixed size. Alternatively, the reference area of a certain character may have a size proportional to the size of that character. When generating the test 400, the server 203 stores the reference coordinates and the reference areas of at least those characters occurring within the string 401.

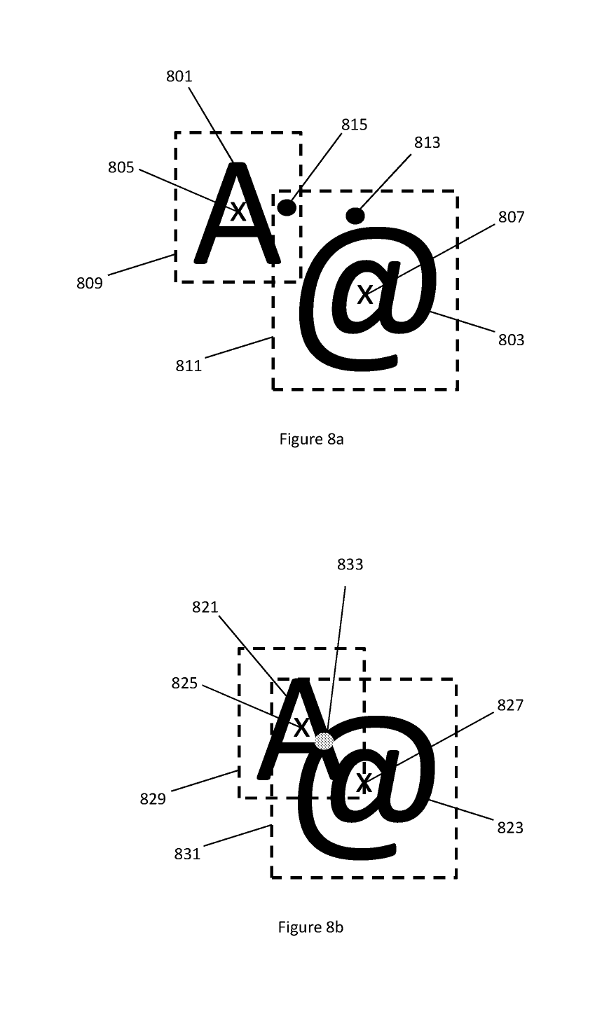

FIG. 8a illustrates a first example of first and second reference coordinates 805, 807 and first and second reference areas 809, 811 for respective first and second characters 801, 803, “A” and “©”. In FIG. 8a, the reference coordinates 805, 807 are indicated by crosses and the reference area 809, 811 are indicated by dotted boxes. As illustrated in FIG. 8a, in some cases, the reference areas 809, 811 of different characters may overlap. In the example of FIG. 8a, the characters 801, 803 do not overlap. Also indicated in FIG. 8a, as filled circles 813, 815, are potential selections by a user.

In one example, if a selection (e.g. selection 813) falls within the reference area of one character only (e.g. reference area 811 of character “@”), then the selection 813 is determined to be a selection of that character (“@”). On the other hand, if a selection (e.g. selection 815) falls within the reference areas of two or more characters (e.g. reference areas 809 and 811 of respective characters “A” and “@”), then the selection 815 may be determined to be ambiguous. In this case, to resolve the ambiguity, the character having the closest reference coordinates to the selection 815 may be determined as the selected character (e.g. “A”).

In another example, the character having the closest reference coordinates to a selection (e.g. selection 815) may be determined directly as the selected character (e.g. “A”), without considering reference areas.

FIG. 8b illustrates a second example of first and second reference coordinates 825, 827 and first and second reference areas 829, 831 for respective first and second characters 821, 823, “A” and “©”. In the example illustrated in FIG. 8b, the characters 821, 823 overlap, and a selection 833 made by the user falls within the reference areas 829, 831 of both characters 821, 823 and actually touches both characters 821, 821. The techniques described above in relation to FIG. 8a may be applied equally to the example illustrated in FIG. 8b.

The skilled person will appreciate that any other suitable technique may be used to determine which character a user has selected, and that the present invention is not limited to the examples described above and illustrated in FIGS. 8a and 8b.

When the user has selected a character in the image 403, the server 203 determines which character the user has selected by comparing the coordinates of the user's selection received from the client device 401 with the reference coordinates and the reference areas stored by the server 203. For example, in certain embodiments, as described above, the character having a reference area into which the coordinates of the user's selection falls is determined as the character selected by the user. Alternatively (or in the case of ambiguity if a selection falls into two or more reference areas), the character having reference coordinates that are closest to the coordinates of the user's selection is determined as the character selected by the user.

In the case that one or more of the characters move, the reference coordinates and/or reference areas of the moving characters at a particular time may be determined, for example, based on initial reference coordinates and/or reference areas (corresponding to the reference coordinates and/or reference areas at an initial time) together with the known motion of the characters and the known elapsed time since the initial time.

When the server 203 has determined which character the user has selected, the server 203 compares the selected character with a corresponding character in the string 401. The corresponding character refers to a character the user is required to select with the current selection. For example, if the user is required to select characters in the string 201 in a specific order, the corresponding character may be a specific character in the string 201 in that order. If the user is not required to select characters in the string 201 in any particular order, the corresponding character may be any character in the string 201 that has not yet been selected with previous user selections.

If the character selected by the user in the image 403 matches the corresponding character in the string 401, then the server 203 determines that the user has selected the correct character. The above process is repeated for each character in the string 401, and if the user selects the correct character for each character in the string 401, then the server 203 determines that the user has passed the test 400. The server 203 may then transmit a signal to the client device 201 authorizing access by the client device 201 to the information and/or service requested by the client device 201.

In the case that the client device 201 transmits a portion of test response information to the server 203 each time the user selects a character in the image 403, the server 203 may determine whether the user has correctly selected each character as each portion of test response information is received. Alternatively, the server 203 may buffer the received portions of test response information as they are received from the client device 201 and determine whether the user has correctly selected each character using the buffered information upon completion of the test.

Conventional CAPTCHA type tests typically require a user to input characters using a keyboard or keypad. Therefore, either a physical keyboard/keypad must be provided, or a virtual keyboard/keypad must be displayed on a screen. However, many devices, for example a touchscreen-based portable terminal do not typically provide a physical keyboard/keypad. Furthermore, a virtual keyboard/keypad typically occupies a significant portion of the overall screen area of a display, resulting in inconvenience. In contrast, in embodiments of the present invention, the user may conduct a test by directly selecting characters within an image, rather than by typing characters using a physical or virtual keyboard/keypad. This eliminates the need to provide a physical keyboard/keypad or to display a virtual keyboard/keypad, thereby increasing convenience.

In addition, since embodiments of the present invention are based on directly selecting characters within an image, rather than by typing characters using a keyboard, this provides an advantage that the test may be easier to perform by a person with dyslexia or other similar condition.

Furthermore, by providing a zoom function in certain embodiments of the present invention, the test may be easier to perform by a person with a visual impairment.

In the embodiments described above, the first output comprises a string 401. However, in certain other embodiments, the first output may be provided in any suitable form that indicates a set of characters to a human user. The set of characters may be defined in a particular sequence, or may be unordered. For example, the first output may alternatively be provided in the form of an image, a video or an audio recording. For example, in the case of an audio recording, the user may provide an input (e.g. press a button or select an icon) which causes the playing of an audio recording of a voice that reads out a sequence of one or more characters, or if the sequence of characters is a word or phrase, the voice reads the word or phrase.

In certain embodiments of the present invention, the first output may be provided in the form of a logo, brand or advertisement containing a sequence of characters. In this way, the user of the client device 201 is exposed to an advertisement when conducting the test 400, thereby helping to generally increase the exposure of the logo, brand or advertisement.

In other embodiments, the first output may be provided in the form of a sequence of different logos or brands, and the characters forming the image 403 may be replaced with a set of various logos or brands. In this way, multiple brands or logos may be exposed to the user each time a test is conducted.

The party wishing to advertise the brands or logos may make a payment to the party managing the server and the test procedure described above, in exchange for increasing exposure to the brand or logo, thereby providing a revenue stream to the party managing the server and test procedure.

In addition, any party wishing to use a test or challenge according to the present invention may receive a payment, for example at least a part of the payment made by the party wishing to advertise a brand or logo (e.g. advertising revenue), thereby encouraging the adoption/deployment of embodiments of the present invention.

In conventional CAPTCHA-type tests, a displayed “challenge string” is distorted and a user is required to input the characters forming the challenge string into an input text box using a keyboard. In contrast, in certain embodiments of the present invention, a challenge string (e.g. the string 401 illustrated in FIG. 4) may be displayed without any distortion or other type of obfuscation. Furthermore, in certain embodiments of the present invention, rather than using an input text box, an image or “input pad” (e.g. the image 403 illustrated in FIG. 4) is displayed. The user may select points on the input pad (e.g. by “clicking”) to provide input. The input pad comprises one or more characters having at least some obfuscation applied thereto. Accordingly, a computer program cannot easily derive challenge string information from the input pad.

In the following, exemplary methods for generating a test for distinguishing between a human and a computer program, and exemplary methods for determining which character has been selected by a user during performance of the test, are described. For example, the test may be in the form of any of the tests described above.

As described above, in certain embodiments, the test includes an image comprising a two-dimensional arrangement of various characters. For example, in certain embodiments, the characters may comprise one or more glyphs. Each character may be randomly chosen from a set of characters. In some embodiments, some or all of the characters may have one or more of their characteristics varied. The characteristics may include, for example, one or more of typeface, font size, weight (e.g. bold), slope (e.g. oblique and italic), width and serif. In some embodiments, some or all of the characters may have one or more transformations applied thereto. The transformations may include, for example, one or more of rotation, reflection and a shape-deforming transformation.

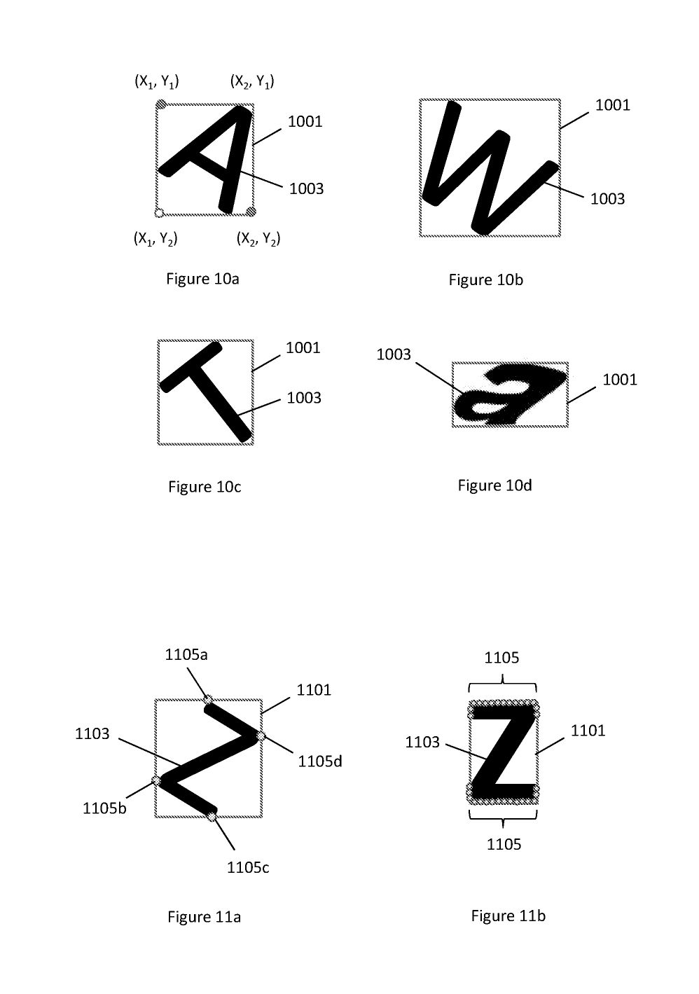

Once a character has been selected for inclusion in the character array, the characteristics of the character have been determined, and any transformations applied to the character, a “bounding box” of the character may be defined. A bounding box may be defined as an imaginary quadrilateral (e.g. rectangle or square) having the smallest size (e.g. the smallest area) that fully encloses the character. According to this definition, a character will touch the edge of its bounding box at two or more points, which are referred to below as “touching points”. FIGS. 10a-d illustrate various examples of rectangular bounding boxes 1001 for various characters 1003, “A”, “W”, “T” and “a”. FIGS. 11a-b illustrate examples of touching points 1105 for different orientations of the character “Z”.

A bounding box 1001 may be defined such that the sides of the bounding box are aligned with a certain axis, for example the x and y axis of the image comprising the character array. In the case of a square or rectangle, a bounding box 1001 may be defined by the coordinates of two diagonally opposing corners of the bounding box 1001. For example, the diagonally opposing corners may be the top-left and bottom-right corners (having coordinates (x₁, y₁) and (x₂, y₂), respectively, as illustrated in FIG. 10a), or the top-right and bottom-left corners (having coordinates (x₂, y₁) and (x₁, y₂), respectively, as illustrated in FIG. 10a). In this case, the coordinate x₁ is given by the x-coordinate of the point (e.g. pixel) of the character 1003 having the lowest valued x-coordinate. The coordinate x₂ is given by the x-coordinate of the point (e.g. pixel) of the character 1003 having the highest valued x-coordinate. The coordinate y₁ is given by the y-coordinate of the point (e.g. pixel) of the character 1003 having the highest valued y-coordinate. The coordinate y₂ is given by the y-coordinate of the point (e.g. pixel) of the character 1003 having the lowest valued y-coordinate.

After a character 1003 has been selected, the characteristics of the character 1003 have been determined, and any transformations applied to the character 1003, a “character shape” of the character may be defined. A character shape may be defined as a closed shape having minimal perimeter length that completely encloses the character 1003. The character shape of a character is the shape that an elastic band would form if allowed to contract around the character 1003. A character shape may be determined by any suitable algorithm. In certain embodiments, a character shape may be approximated by a “character box”, which may be determined in a manner described below.

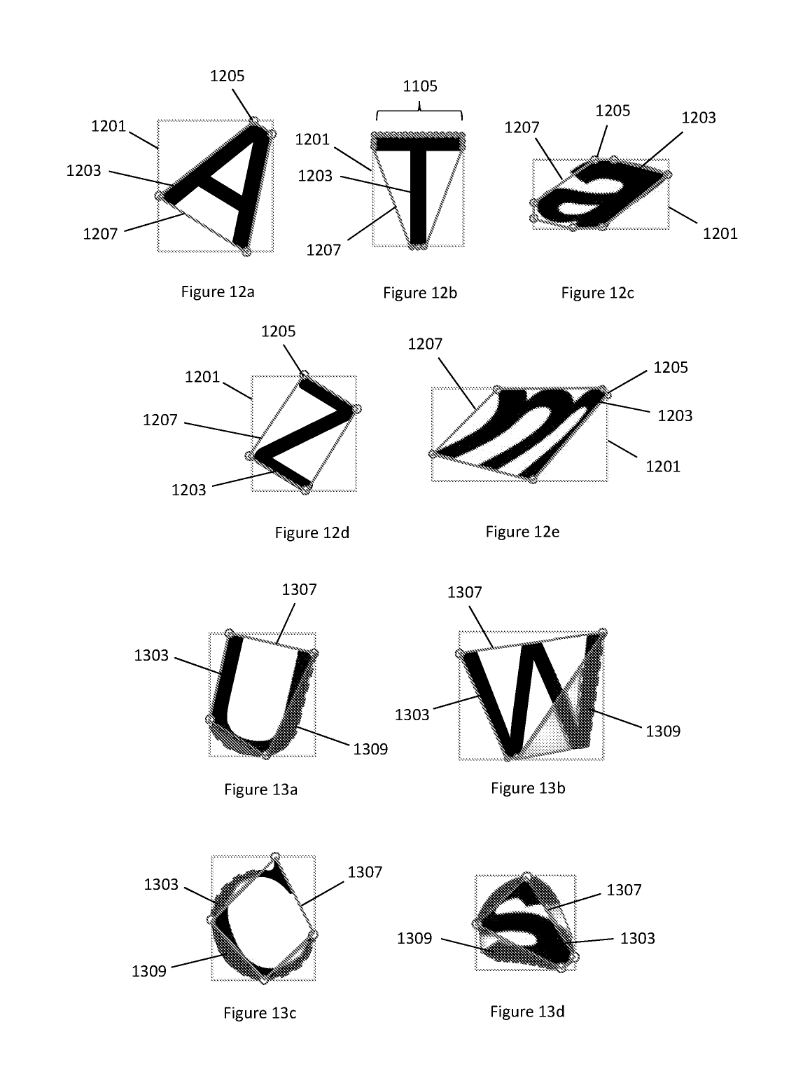

To determine a character box, in a first step, the bounding box 1101 of a character 1103 is determined. In a next step, the touching points 1105a-d of the character 1103 (i.e. the points at which the character 1103 touches the bounding box 1101) are determined. In a next step, the touching points 1105a-d are ordered in a cyclic sequence according to the order in which the touching points 1105a-d occur when traversing the perimeter of the bounding box 1101 in a certain direction (e.g. clockwise or ant-clockwise). For example, the touching points 1105a-d illustrated in FIG. 11a may be ordered into the sequence {1105a, 1105b, 1105c, 1105d} based on an anti-clockwise traversal of the bounding box 1101 perimeter. In a next step, the character box is defined as a polygon whose edges comprise straight lines formed by connecting consecutive touching points 1105a-d in the sequence of touching points 1105a-d (including connecting the first and last touching points in the sequence). For example, in the example illustrated in FIG. 11a, the pairs of touching points {1105a, 1105b}, {1105b, 1105c}, {1105c, 1105d} and {1105d, 1105a} are connected by straight lines to form the edges of the character box polygon. FIGS. 12a-e illustrate examples of character boxes 1207 for characters “A”, “T”, “Z”, “m” and “a”.

A character shape and a character box 1207 are intended to represent the general shape of a corresponding character 1203. However, the accuracy with which a character box 1207 determined according to the method described above represents the shape of a corresponding character 1203 may vary. In some cases, a character box 1207 may not represent the shape of a character 1203 sufficiently accurately for some applications, for example in the case of some rotated characters (e.g. some angles for some uppercase letters “C”, “D”, “G”, “Q”, “R”, “U” and “W”). FIGS. 13a-d illustrate character boxes 1307 for characters 1303 “U”, “W”, “C” and “S”. In these examples, it can be seen that a significant portion of each character 1303 falls outside the respective character box 1307, as indicated by the areas 1309 bounded by dotted lines in FIGS. 13a-d.

The size of the area of a character 1303 that falls outside the character's character box 1307 (referred to below as an “outlying area” 1309) may be used to define an accuracy measure for the character box 1307. For example, the accuracy measure may be based on one or more of the absolute size of the outlying area 1309, and the size of the outlying area 1309 relative to the total area of the character 1303 (e.g. the size of the outlying area 1309 divided by the total area of the character 1303). In some embodiments, a character box 1307 may be regarded as acceptable if the accuracy measure satisfies a certain condition (e.g. the accuracy measure is greater than a threshold value). For example, in some embodiments, based on a certain accuracy measure, the case illustrated in FIG. 13a may be regarded as acceptable, while the cases illustrated in FIGS. 13b-d may be regarded as unacceptable.

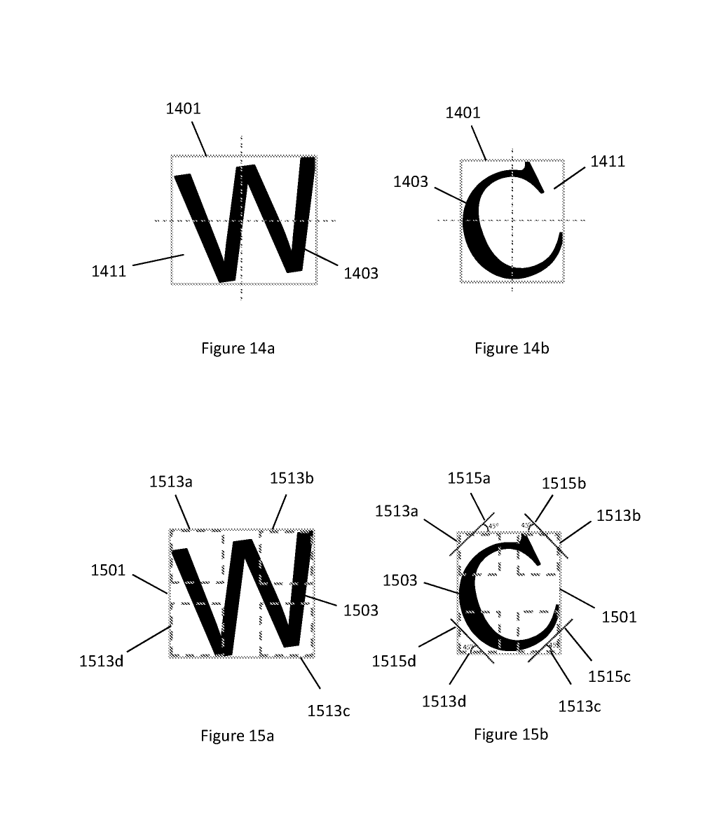

In cases where the character box 1307 is unacceptable, the character box 1307 may be modified to make the character box 1307 more representative of the shape of the corresponding character 1303. One exemplary method for modifying the character box 1307 is described in the following with reference to FIGS. 14-17.

In a first step, the bounding box 1401 of a character 1403 is divided into four equal sized quadrants 1411, each quadrant 1411 having a width a and height b. Examples of this step are illustrated in FIGS. 14a and 14b.

In a next step, four (e.g. equal sized) squares 1513 (or rectangles) are defined, where the side length of each square 1513 (or the length of the longer side in the case of a rectangle) is less than or equal to the smaller of a and b (i.e. the smaller of the width and height of each quadrant 1411 of the bounding box 1501). The squares 1513 are positioned such that each square 1513 is fully enclosed within the bounding box 1501, and such that a corner of each square 1513 coincides with a respective corner of the bounding box 1501. Examples of this step are illustrated in FIGS. 15a and 15b.

In a next step, each square 1513 is scanned using a scan-line 1515 that is inclined with respect to the x-axis. The scan-lines 1515a, 1515c for the upper-left and lower-right squares 1513a, 1513c may be inclined by an angle +θ, and the scan-lines 1515b, 1515d for the upper-right and lower-left squares 1513b, 1513d may be inclined by an angle −θ (e.g. θ=45 degrees). The upper-left square 1513a is scanned from the upper-left corner to the lower-right corner. The upper-right square 1513b is scanned from the upper-right corner to the lower-left corner. The lower-left square 1513d is scanned from the lower-left corner to the upper-right corner. The lower-right square 1513c is scanned from the lower-right corner to the upper-left corner. FIG. 15b illustrates exemplary scan-lines 1515a-d. Each square 1513 is scanned until the scan-line 1515 intersects a point of the character 1503 (or possibly a set of points), resulting in four points (one for each square 1513). These points (“scan-line points”) and the previously determined touching points 1205 are then combined to form a combined set of points. The modified bounding box 1707 is then defined as a polygon whose edges comprise straight lines formed by sequentially connecting points in the combined set of points (touching points and scan-line points).

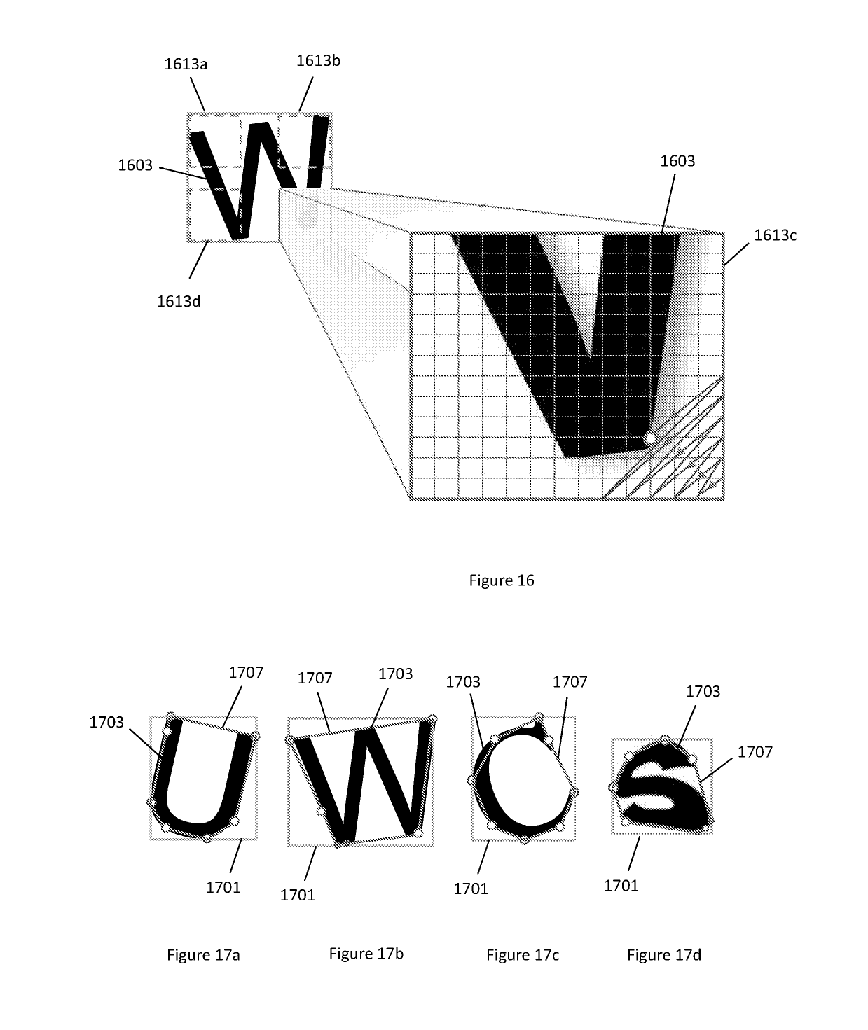

In the case that the character 1603 is displayed in the form of an array of pixels, the scanning may be achieved by traversing the pixels of a square 1513 in a diagonal zig-zag pattern until arriving at the first pixel forming part of the character 1503. FIG. 16 illustrates an exemplary zig-zag pattern for scanning pixel 1513cs in the lower-right square. In other embodiments, a zig-zag pattern different from the specific example illustrated in FIG. 16 may be used, while still generally scanning the squares 1613a-d in the same direction (e.g. scanning from the bottom-right corner to the upper-left corner for the bottom-right square 1613c).

FIGS. 17a-d illustrate the modified character boxes 1707 obtained using the method described above for the characters “U”, “W”, “C” and “S”. It can be seen that the modified character boxes 1707 more closely represent the shapes of their respective characters 1703 than the original character boxes 1307 illustrated in FIGS. 13a-d.

In the embodiment described above, four squares are used. However, in other embodiments, a different number of squares and/or different shapes may be used. For example, a certain number of squares (or other shapes) may be positioned around a boundary region of the bounding box. Each square (or other shape) may be scanned using a scan line inclined by a suitable amount. The scan-lines may be defined such that each square (or other shape) is scanned in a direction moving from the edge of the bounding box to the interior (e.g. centre) of the bounding box. For example, the inclination of the scan-lines may increase (or decrease), for squares (or other shapes) occurring when traversing the boundary region of the bounding box in a certain direction. For example, in the case that eight squares are positioned around the boundary region of the bounding box, such that three squares are positioned along each side of the bounding box, then the corner squares may use scan-lines as illustrated in FIG. 15b, while the middle squares along each side may use scan-lines inclined either horizontally (for the upper and lower sides) or vertically (for the left and right sides).

Next is described a method for generating an image comprising a two-dimensional arrangement of various characters for use in a test. The characters are arranged so that a character connects with one or more of its neighbouring characters. In some embodiments, the connection between neighbouring characters may comprise a certain degree of overlap between one or more characters. However, in the following embodiment, the connection is in the form of touching, but without overlap or with no substantial overlap. In certain embodiments, the characters are arranged so that each character connects with all neighbouring characters in each direction as much as possible.

In general, embodiments insert a first character within the image at a certain location, which may be selected randomly or according to a certain pattern. One or more characters may be inserted in this way. To insert a second character in the image, the second character may be initially positioned such that there is no overlap between the second character and a previously inserted character (e.g. the first character). The second character is then slid in a certain direction until the second character touches a previously inserted character (or overlaps a previously inserted character to a desired degree). The direction in which the second character is slid may depend on the particular pattern of characters desired in the final image. The second character may be slid two or more times in different directions order to determine its final position in the image.

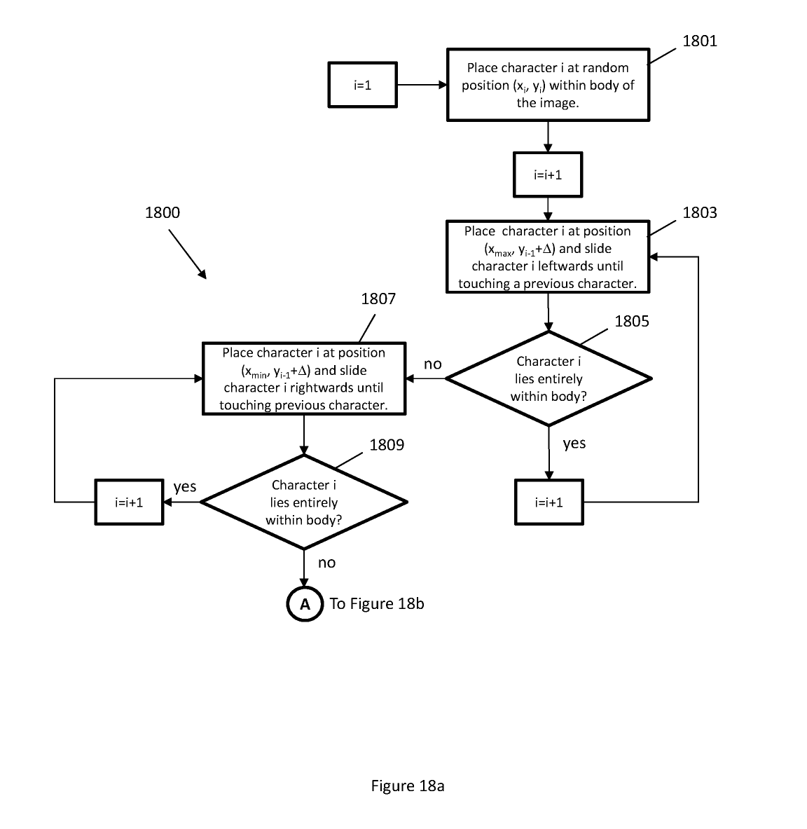

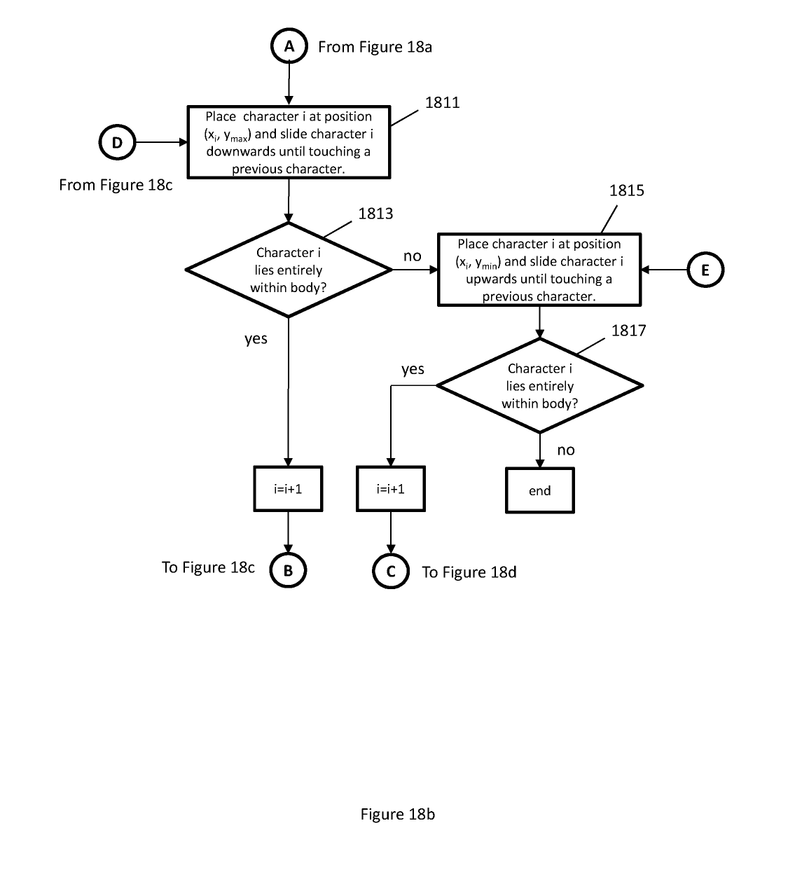

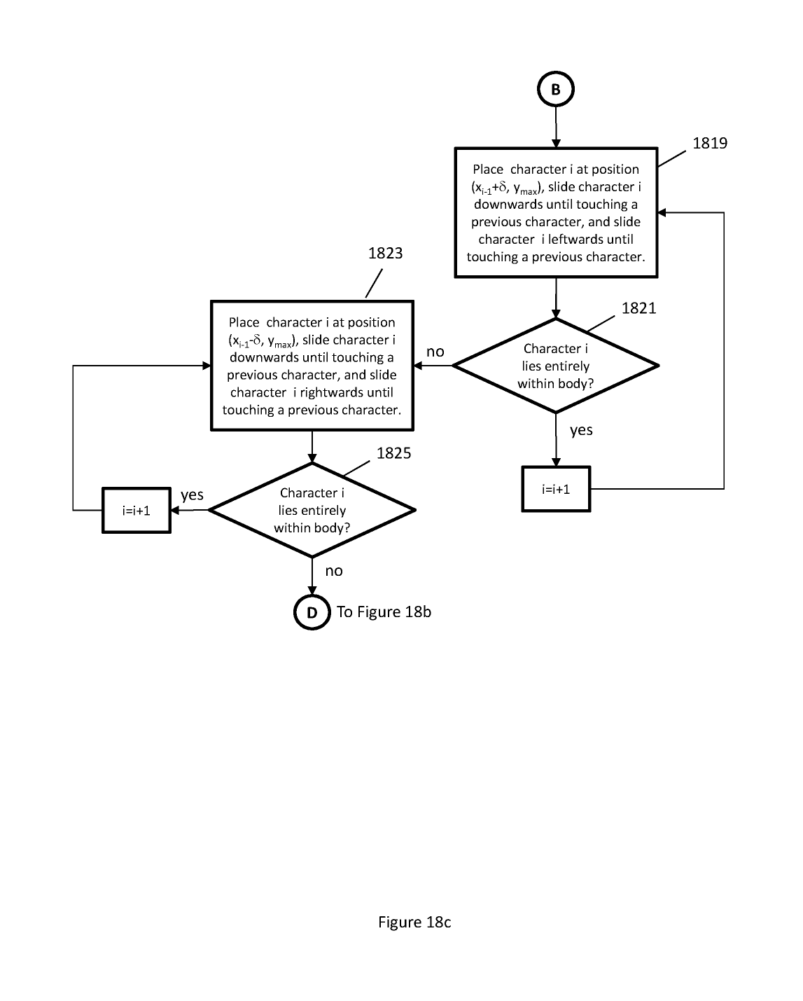

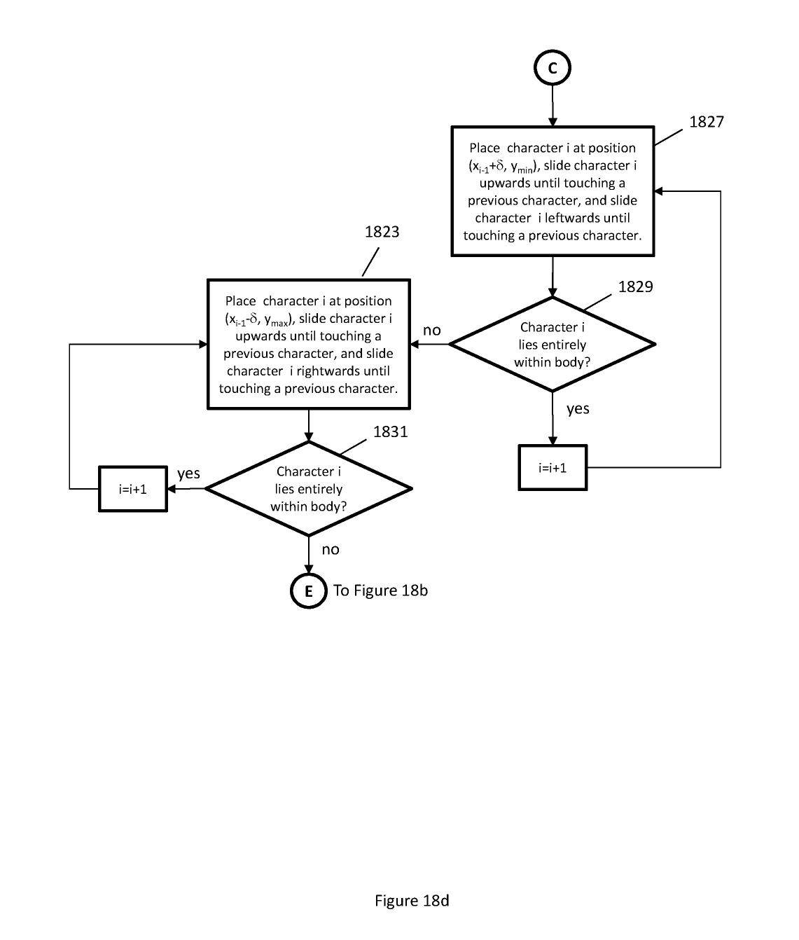

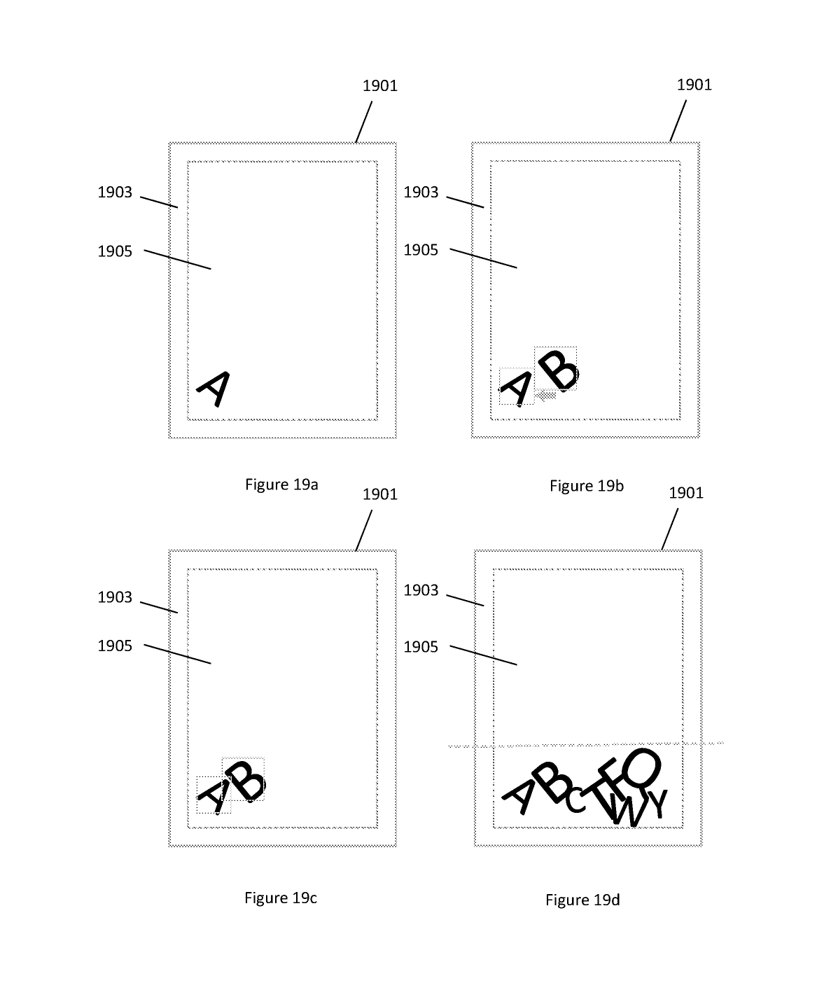

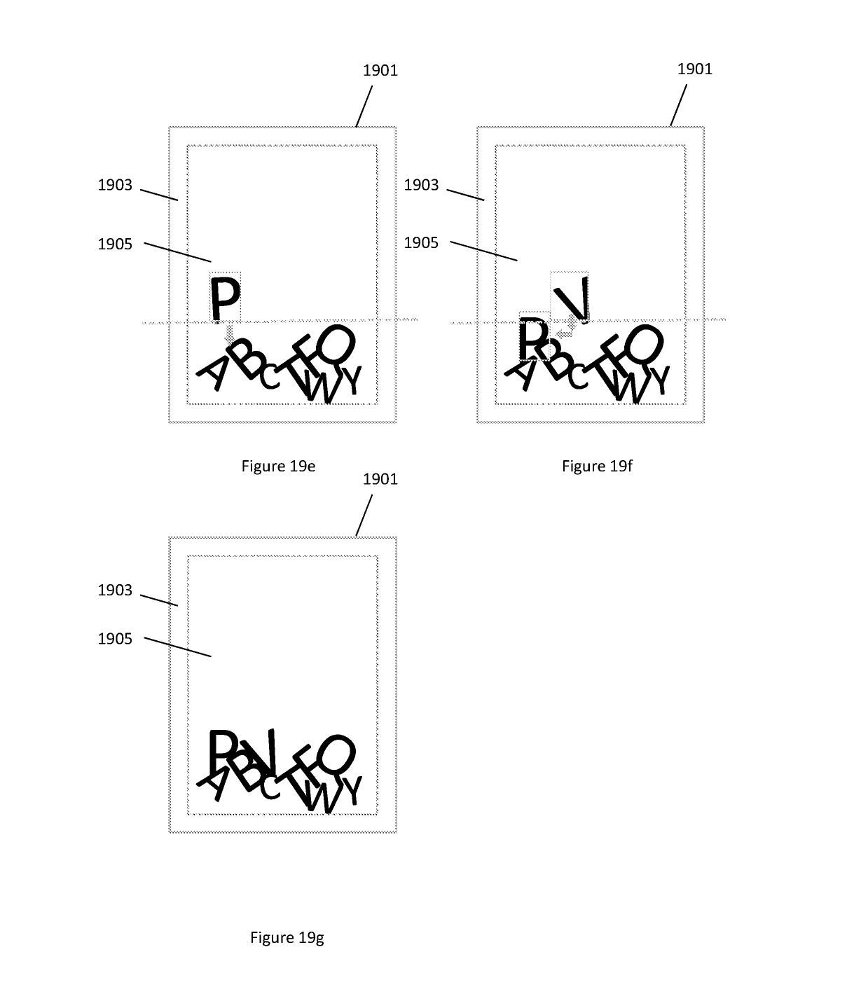

FIGS. 18a-c illustrate one exemplary method for arranging the characters. FIGS. 19a-h illustrate the various steps in the method of FIG. 19.

FIG. 19a illustrates an image into which the characters are to be arranged. In the illustrated example, the image 1901 is provided with a margin 1903 comprising an area that remains empty and a body 1905 comprising an area into which the characters are placed. The margin 1903 may be any suitable size, for example 40 pixels wide. In some embodiments, the margin may be omitted.

In the following example, characters are arranged roughly in rows, wherein characters are added sequentially to an existing row, and when a row becomes full, a next row is created, until the image becomes full. FIG. 18a illustrates the part of the method for creating and filling a first row, FIG. 18b illustrates the part of the method for creating a next row, and FIGS. 18c and 18d illustrate the part of the method for filling a next row.

In a first step 1801, a character (referred to below as a first character) is placed at a random position within the body to create a first row. For example, as illustrated in FIG. 18a, the character may be placed close to one of the corners of the body. The position of the character within the image may be defined in any suitable way, for example by the central point of the bounding box of the character, or one of the corners of the bounding box. The position of the first character may be denoted by coordinates (x, y), where x and y may be randomly selected.

In a next step 1803, a next character (referred to below as a second character) is initially placed at a position (xₘₐₓ, y+Δ), where xₘₐₓ denotes a maximum x-coordinate and denotes a random variation in the y-direction. The value Δ, which is generally different for each character, may be generated according to any suitable random distribution, for example a uniform distribution between a minimum value (e.g. −M) and a maximum value (e.g. +M), or a Gaussian distribution having a mean μ (e.g. μ=0) and standard deviation σ. Accordingly, the second character is initially placed at the right-most portion of the image at approximately the same vertical position as the first character but with a random variation in the vertical position. In an alternative embodiments, Δ=0 such that there is no variation in the vertical position of the characters in a row. The second character is then slid leftwards, as indicated by the arrow in FIG. 19b, until the second character touches any previously arranged character (i.e. the first character) at at least one point. The second character may be slid so far as to only touch the first character, with substantially no overlap between the characters. Alternatively, a certain degree of overlap may be allowed between the characters.

In a next step 1805, it is determined whether the second character is lying entirely within the body. If the second character is lying entirely within the body then the second character is regarded as having been successfully added to the current row (as illustrated in FIG. 19c), and steps 1803 and 1805 are repeated for the next character (as illustrated in FIG. 19d). On the other hand, if the second character is not lying entirely within the body, for example because there is insufficient space on the right-hand side of the first character, then a similar process is attempted to add the second character to the current row on the left-hand side of the first character, and the method proceeds to step 1807.

In step 1807, the second character is initially placed at a position (xₘᵢₙ, +Δ), where xₘᵢₙ denotes a minimum x-coordinate, and the second character is slid rightwards until the second character touches any previously arranged character (i.e. the first character). In a next step 1809, it is determined whether the second character is lying entirely within the body. If the second character is lying entirely within the body, then the second character is regarded as having been successfully added to the current row, and steps 1807 and 1809 are repeated for the next character.

If the second character is not lying entirely within the body, for example because there is insufficient space on the left-hand side of the first character, this indicates that the current row of characters is full and a next row should be created, in which case, the method proceeds to step 1811.

In step 1811, a next character (referred to below as a third character) is arranged at a position (x, yₘₐₓ), where x may be randomly selected and yₘₐₓ denotes a maximum y-coordinate. The third character is then slid downwards, as indicated by the arrow in FIG. 19e, until the third character touches any previously arranged character (i.e. the characters in the previous row) at at least one point.

In a next step 1813, it is determined whether the third character is lying entirely within the body. If the third character is not lying entirely within the body, this indicates that there is insufficient space for a new row above the previous row. In this case, the method proceeds to step 1815, wherein creation of a row below the previous row is attempted.

In step 1815, the third character is arranged at a position (x, yₘᵢₙ), where yₘᵢₙ denotes a minimum y-coordinate. The third character is then slid upwards until the third character touches any previously arranged character (i.e. the characters in the previous row) at at least one point.

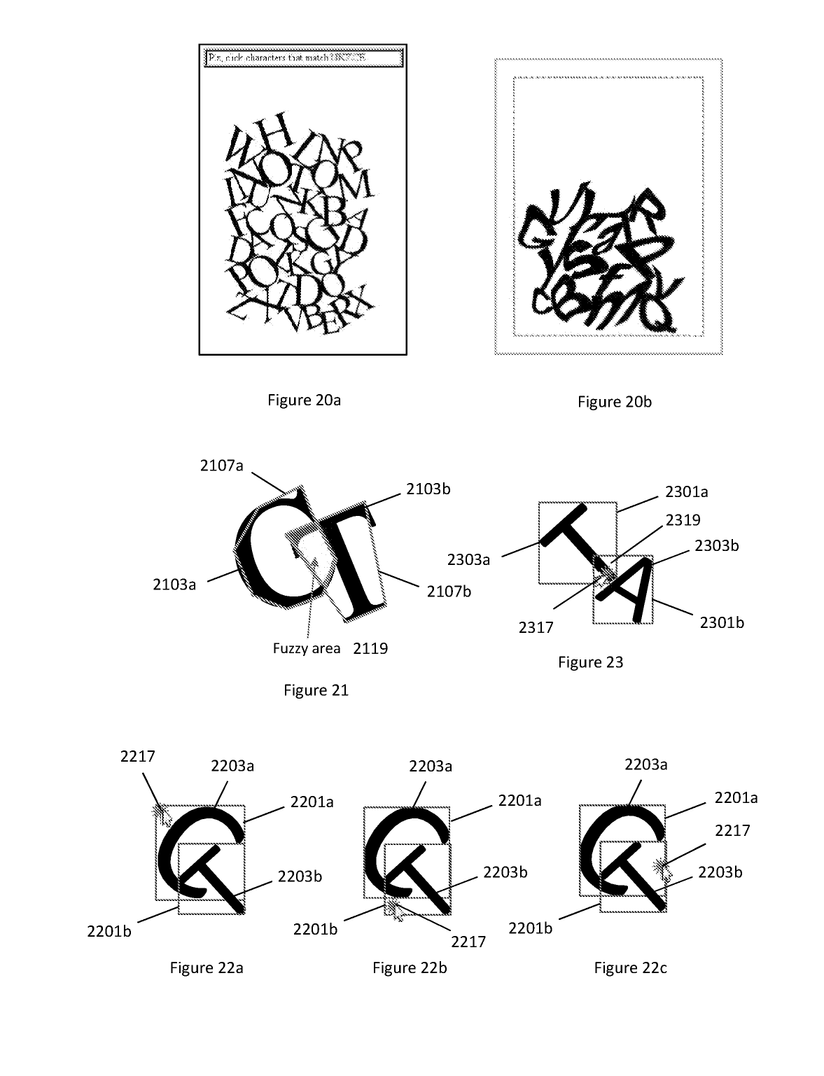

In a next step 1817, it is determined whether the third character is lying entirely within entirely within the body. If the third character is not lying entirely within the body, this indicates that there is insufficient space for a new row below the previous row. In this case, it is not possible to add any more rows to the image and the method ends. An example of an image resulting from the method of FIG. 18 is illustrated in FIG. 20a. Another example of an image resulting from the method of claim 18, in which distortion has been applied to the characters, is illustrated in FIG. 20b,

If, in either of steps 1813 or 1817, it is determined that the third character is lying entirely within the body then a new row containing the third character is regarded as having been successfully created, either above the previous row (as illustrated in FIG. 19f) or below the previous row. The position of the third character may be denoted (x,y). In this case, the method proceeds to either step 1819 (from step 1813) or step 1827 (from step 1817), wherein characters are added to the new row.

In step 1819, a next character (referred to below as a fourth character) is arranged at a position (x+δ, yₘₐₓ), where δ denotes a certain displacement in the x-coordinate that is set to be larger than the size of the largest character. As illustrated in FIG. 19f, the fourth character is then slid downwards until it touches a previously arranged character and then slid leftwards until it touches a previously arranged character.

In a next step 1821, it is determined whether the fourth character is lying entirely within the body. If the fourth character is lying entirely within the body, the fourth character is regarded as having been successfully added to the current row, as illustrated in FIG. 19g, and steps 1819 and 1821 are repeated for the next character in the current row.

On the other hand, if the fourth character is not lying entirely within the body, this indicates that there is insufficient space for the fourth character on the right-hand side of the current row. In this case, the method proceeds to step 1823 wherein it is attempted to add the fourth character to the left-hand side of the current row.

In step 1823, the fourth character is arranged at a position (x−δ, yₘₐₓ). The fourth character is then slid downwards until it touches a previously arranged character and then slid rightwards until it touches a previously arranged character.

In a next step 1825, it is determined whether the fourth character is lying entirely within the body. If the fourth character is lying entirely within the body, the fourth character is regarded as having been successfully added to the current row and steps 1823 and 18225 are repeated for the next character in the current row. On the other hand, if the fourth character is not lying entirely within the body, this indicates that the current row of characters is full and a next row should be created, in which case, the method proceeds to step 1811, wherein creation of a new row above the current row is attempted.

Steps 1827 to 1831 illustrated in FIG. 18d are similar to steps 1819 to 1825 illustrated in FIG. 18c, except that the fourth character is slid downwards instead of upwards. In addition, in step 1831, if the fourth character is not lying entirely within the body, the method proceeds to step 1815, wherein creation of a new row below the current row is attempted. Accordingly, steps 1827 to 1831 will not be described in detail.

In the above example, the characters are arranged roughly in rows. However, in other embodiments, the characters may be arranged differently, for example in columns or inclined rows or columns. Furthermore, in the above example, new characters are first added to the right of an existing row, then to the left, while new rows are first created above existing rows, then below. However, in alternative embodiments, this ordering may be modified.

The present invention encompasses many different ways in which characters may be added to the image. For example, in one embodiment in which characters are arranged roughly in a spiral pattern, a first character may be placed at a certain position in the image (e.g. at the centre of the image). A second character may be slid along a spiral pathway emanating from the first character towards the first character until the second character touches the first character. A process of sliding characters towards previously positioned characters along the spiral pathway may be repeated until no more characters can be added.

In another example in which characters are arranged randomly, one or more characters may be positioned at random (non-overlapping) positions within the image. Then a new character may be placed at a random initial position on the boundary of the image and then slid into the image in a random direction (e.g. horizontally or vertically selected at random) until the new character touches a previously inserted character (in which case the new character is regarded as having been successfully inserted), or the new character reaches a boundary of the image (in which case the new character is not inserted). A process of sliding new characters in this way may be repeated until no more characters can be added.

It will be appreciated that the present invention is not limited to the above examples, and may include any embodiments in which one or more characters are placed at certain positions, and further characters are added by sliding a new characters until the new character touches (or overlaps) a previously inserted character.

As described above, when a user performs a test, the user is required to select characters in the image, for example by clicking a point in the image with a mouse. However, in many cases, there may be some ambiguity as to which character the user intended to select.

In some embodiments, a user may be regarded as selecting a certain character if the user selects a point (pixel) in the image contained within that character's bounding box. In other embodiments, a user may be regarded as selecting a certain character if the user selects a point in the image contained within that character's character box (or character shape).

However, in many cases, the bounding boxes, character boxes and/or character shapes of different characters in the image overlap (creating “fuzzy areas”). An example of a fuzzy area 2119 in which the character boxes of two characters “C” and “T” overlap is illustrated in FIG. 21. In the case that the user selects a point (pixel) contained within more than one character's bounding box, character box or character shape (i.e. the user selects a point in a fuzzy area), an ambiguity arises as to which character the user intended to select.

In some embodiments, it may be preferable to determine which character a user has selected based on character boxes (or character shapes) rather than bounding boxes. For example, a bounding box does not generally represent the shape of its character very well. consequently, in many cases, a bounding box contains redundant areas (e.g. at its corners) that are outside the character's outline, which may result in a relatively high number of mistakes or inaccuracies in determining which character a user intended to select.

For example, FIG. 22a illustrates a case that a user has selected a point 2217 that may be outside the acceptable boundary of the character “C”, but would be deemed by the system to be a correct selection of “C” since the point is located in the bounding box of “C”. FIG. 22b illustrates a case that a user has selected a point 2217 that lies within the bounding box of “T” but not the bounding box of “C”, even though the selected point is closer to “C” than “T”. Therefore, the system would determine that the user intended to select “T” even though the user may have intended to select “C”. FIG. 22c illustrates a case that a user has selected a point 2217 that lies within the bounding boxes of both “C” and “T”. Therefore, the system would determine that the user intended to select one of “C” and “T”. However, since the selected point lies relatively far from both “C” and “T”, it may not be acceptable for this user selection to represent either “C” or “T”.

FIG. 23 illustrates a case in which the user has selected a point 2317 in the fuzzy area 2319 of overlap between the bounding boxes of characters “T” and “A”. Since the user selected a point that lies within the outline of “T” it is likely that the user intended to select “T”. The user may not realise that the selected point lies within a fuzzy area. However, the system cannot resolve the ambiguity based on the bounding boxes alone since the point falls within two bounding boxes. This may lead to incorrect interpretation of the user selection. For example, if the system were to select the character having a boundary box whose centre is closest to the selected point, then the system would select “A” rather than “T”, even though the user selected a point inside the outline of “T”.

Accordingly, in certain embodiments, the character box (or character shape), rather than the bounding box, may be used to determine which character the user intended to select. A character box or character shape typically represents the shape of a character more closely than a bounding box, and therefore use of a character box or character shape is more likely to reflect a user's intended selection than using a bounding box. Using a character box may alleviate many of the problems arising from ambiguous user selection, for example the cases illustrated in FIGS. 22 and 23.

It will be appreciated that embodiments of the present invention can be realized in the form of hardware, software or a combination of hardware and software. Any such software may be stored in the form of volatile or non-volatile storage, for example a storage device, ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain embodiments thereof, it will be understood by those skilled in the art that various changes in form and detail may be made therein without departing from the scope of the invention as defined by the appended claims.

1. A method for distinguishing between a human and a computer program, the method comprising:
providing a first output for indicating a set of one or more graphical entities;
displaying an image comprising an arrangement of a plurality of graphical entities, wherein the graphical entities of the image comprise at least the set of one or more graphical entities indicated by the first output, and wherein one or more of the graphical entities of the image are obfuscated;
receiving an input for selecting one or more points on the image;
comparing the selected points with position information indicating the positions in the image of the set of one or more graphical entities indicated by the first output; and
determining that the received input has been made by a human if the selected points correspond to the position information.

2. The method of claim 1, wherein the first output comprises at least one of: a plaintext string; and a plaintext string displayed as an image.

3. The method of claim 1, wherein the first output comprises an audio output.

4. The method of claim 1, wherein the first output comprises a brand or logo.

5. The method of claim 1, wherein the arrangement of the graphical entities comprises one of: a one-dimensional arrangement of graphical entities; and a two-dimensional arrangement of graphical entities.

6. The method of claim 1, wherein the graphical entities comprised in the image are arranged in one or more of: rows; and columns.

7. The method of claim 1, wherein the graphical entities comprised in the image are arranged in a spiral pattern.

8. The method of claim 1, wherein the graphical entities comprised in the image are arranged randomly.

9. The method of claim 1, wherein the obfuscation comprises one or more of:
applying one or more transformations to one or more of the graphical entities;
applying one or more image processing operations to one or more of the graphical entities;
overlapping one or more of the graphical entities;
superimposing a second image or pattern over the image;
displaying two or more of the graphical entities in different fonts and/or sizes;
moving one or more of the graphical entities; and
causing one or more of the graphical entities to disappear temporarily.

10. The method of claim 9, wherein the overlapping comprises overlapping one or more of the graphical entities with one or more of: upper neighbouring graphical entities; lower neighbouring graphical entities; left neighbouring graphical entities;
right neighbouring graphical entities; and diagonal neighbouring graphical entities.

11. The method of claim 9, wherein the one or more transformations comprise one or more of: a rotation; a reflection; stretching; scaling; tapering; twisting; shearing; warping; and bending.

12. The method of claim 9, wherein the one or more image processing operations comprise one or more of: blurring; shading; patterning; outlining; silhouetting; and colouring.

13. The method of claim 1, wherein the graphical entities comprise one or more of: characters; letters; numbers; punctuation marks; phonetic symbols; currency symbols; mathematical symbols; icons; graphics; and symbols.

14. The method of claim 1, wherein the received input comprises a touch applied to a touchscreen.

15. The method of claim 1, wherein comparing the selected points with position information comprises determining which graphical entity in the image corresponds to each selected point.

16. The method of claim 15, further comprising comparing the graphical entity in the image corresponding to the selected point with a corresponding graphical entity indicated in the first output.

17. The method of claim 16, wherein determining that the received input has been made by a human comprises determining that the graphical entity in the image corresponding to the selected point matches the corresponding graphical entity indicated in the first output.

18. The method of claim 15, wherein the position information comprises a reference area for each of the graphical entities.

19. The method of claim 18, wherein the reference areas comprise one or more of: a square area; a rectangular area; a circular area; and an area having the same or similar shape to a graphical entity.

20. The method of claim 18, wherein the reference areas comprise one or more of: an area of fixed size; and an area having a size proportional to the size of one of the graphical entities.

21. The method of claim 18, wherein determining which graphical entity in the image corresponds to each selected point comprises determining whether a selected point falls within a reference area.

22. The method of claim 21, wherein the position information comprises a reference position for each graphical entity.

23. The method of claim 22, wherein determining which graphical entity in the image corresponds to each selected point comprises determining a reference position that is closest to a selected point.

24. The method of claim 22, wherein determining which graphical entity in the image corresponds to each selected point comprises determining a reference position that is closest to a selected point when the selected point falls within two or more reference areas.

25. The method of claim 1, wherein determining that the received input has been made by a human comprises determining that the selected points are made at a certain time.

26. The method of claim 1, further comprising displaying a second image comprising an arrangement of a plurality of graphical entities, wherein the graphical entities of the second image comprise at least the set of one or more graphical entities indicated by the first output, and wherein one or more of the graphical entities of the second image are obfuscated.

27. The method of claim 1, further comprising displaying a visual indicator at the positions of the selected points.

28. The method of claim 27, wherein the visual indicators comprise an indication of the order of the selected points.

29. The method of claim 1, further comprising receiving test information from a server, the test information comprising the first output and the displayed image.

30. The method of claim 1, further comprising transmitting test response information to a server, the test response information comprising the positions of the selected one or more points.

31. A system for distinguishing between a human and a computer program, the system comprising a client device and a server;
wherein the client device is configured for:
providing a first output for indicating a set of one or more graphical entities;
displaying an image comprising an arrangement of a plurality of graphical entities, wherein the graphical entities of the image comprise at least the set of one or more graphical entities indicated by the first output, and wherein one or more of the graphical entities of the image are obfuscated; and
receiving an input for selecting one or more points on the image;
wherein the server is configured for:
comparing the selected points with position information indicating the positions in the image of the set of one or more graphical entities indicated by the first output; and
determining that the received input has been made by a human if the selected points correspond to the position information.

32. A client device for distinguishing between a human and a computer program, the client device comprising:
a receiver for receiving test information comprising an output and an image, the output for indicating a set of one or more graphical entities, the image comprising an arrangement of a plurality of graphical entities, wherein the graphical entities of the image comprise at least the set of one or more graphical entities indicated by the first output, and wherein one or more of the graphical entities of the image are obfuscated;
an output unit for providing the first output;
a display for displaying the image;
an input unit for receiving an input for selecting one or more points on the image; and
a transmitter for transmitting test response information comprising positions of the selected points.

33. A server for distinguishing between a human and a computer program, the server comprising:
a transmitter for transmitting test information comprising an output and an image, the output for indicating a set of one or more graphical entities, the image comprising an arrangement of a plurality of graphical entities, wherein the graphical entities of the image comprise at least the set of one or more graphical entities indicated by the first output, and wherein one or more of the graphical entities of the image are obfuscated;
a receiver for receiving test response information comprising information indicating one or more selected points on the image; and
a test response analysing unit for comparing the selected points with position information indicating the positions in the image of the set of one or more graphical entities indicated by the first output, and for determining that the selected points have been selected by a human if the selected points correspond to the position information.

34. A method for distinguishing between a human and a computer program, comprising:
receiving test information comprising an output and an image, the output for indicating a set of one or more graphical entities, the image comprising an arrangement of a plurality of graphical entities, wherein the graphical entities of the image comprise at least the set of one or more graphical entities indicated by the first output, and wherein one or more of the graphical entities of the image are obfuscated;
providing the first output;
displaying the image;
receiving an input for selecting one or more points on the image;
transmitting test response information comprising positions of the selected points.

35. A method for distinguishing between a human and a computer program, comprising:
transmitting test information comprising an output and an image, the output for indicating a set of one or more graphical entities, the image comprising an arrangement of a plurality of graphical entities, wherein the graphical entities of the image comprise at least the set of one or more graphical entities indicated by the first output, and wherein one or more of the graphical entities of the image are obfuscated;
receiving test response information comprising information indicating one or more selected points on the image;
comparing the selected points with position information indicating the positions in the image of the set of one or more graphical entities indicated by the first output; and
determining that the selected points have been selected by a human if the selected points correspond to the position information.

36. A method according to claim 18, wherein the reference area for a graphical comprises a bounding box comprising a square or rectangle having the smallest area that fully encloses the graphical entity.

37. A method according to claim 18, wherein the reference area for a graphical entity comprises a closed shape having minimal perimeter length that completely encloses the graphical entity.

38. A method according to claim 37, wherein the reference area comprises a polygon approximation of the closed shape.

39. A method according to claim 38, further comprising:
determining the reference area for a character, wherein determining the reference area comprises:
determining a bounding box comprising a square or rectangle having the smallest area that fully encloses the graphical entity; and
determining the touching points at which the graphical entity touch the bounding box.

40. A method according to claim 39, wherein determining the reference area comprises determining a polygon whose edges comprise straight lines formed by connecting the touching points.

41. A method according to claim 39, wherein determining the reference area comprises:
determining two or more squares positioned around a boundary region of the bounding box;
scanning each square in a direction moving from the edge of the bounding box to the interior of the bounding box using a respective scan line;
determining, for each square, a scan-line point comprising the point at which each scan line initially intersects a point of the graphical entity; and
determining a polygon whose edges comprise straight lines formed by connecting the touching points and scan-line points.

42. A method according to claim 41, wherein the two or more squares comprise four squares located at respective corners of the bounding box, and wherein the scan-lines comprises respective scan-lines inclined at 45 degrees, 135 degrees, 225 degrees and 315 degrees.

43. A method for generating an image comprising an array of characters for use in a test for distinguishing between a human and a computer program, the method comprising:
inserting a first graphical entity into the image;
inserting a second graphical entity into the image;
sliding the second graphical entity in a first direction until the second graphical entity touches a previously inserted graphical entity.

44. A method according to claim 43, wherein inserting the second graphical entity comprises inserting the second graphical entity in a same row or column as the first graphical entity, and wherein sliding the second graphical entity comprises sliding the second graphical entity in the direction of the first graphical entity.

45. A method according to claim 44, wherein inserting the second graphical entity in a same row or column as the first graphical entity comprises adding a random offset to the position of the second graphical entity with respect to the position of the row or column.

46. A method according to claim 44, further comprising repeating the operations of inserting a second graphical entity and sliding the second graphical entity until a row or column is determined as being full.

47. A method according to claim 43, wherein inserting the second graphical entity comprises inserting the second graphical entity in a position above or below an existing row, or a position to the right or left of an existing column, and wherein sliding the second graphical entity comprises sliding the second graphical entity in the direction of the existing row or column.

48. A method according to claim 47, wherein inserting the second graphical entity in a position above or below an existing row, or a position to the right or left of an existing column, comprises inserting the second graphical entity at a position that is offset from a previously inserted graphical entity in a row or column by an amount greater than or equal to the size of a graphical entity.

49. A method according to claim 43, further comprising sliding the second graphical entity in a second direction until the second graphical entity touches a previously inserted graphical entity.

50. A method according to claim 43, further comprising repeating the operations of inserting the second graphical entity and sliding the second graphical entity until the image is determined as being full.
